(19) United States
(12) Patent Application Publication
(10) Pub. No.: US 2026/0348894 A1
(43) Pub. Date: Nov. 5, 2026

(54) INFORMATION PROCESSING METHOD AND INFORMATION PROCESSING APPARATUS

(71) Applicant: BRIDGESTONE CORPORATION, Tokyo (JP)

(72) Inventor: Shu KONDO, Chuo-Tokyo (JP)

(73) Assignee: BRIDGESTONE CORPORATION, Tokyo (JP)

(21) Appl. No.: 19/486,553

(22) PCT Filed: Nov. 21, 2023
(86) PCT No.: PCT/JP2023/041842

§ 371 Date: Nov. 21, 2025

(30) Foreign Application Priority Data
May 31, 2023 (JP) 2023-090197

(51) Int. Cl. G01N 25/72; B60C 25/00; G01M 17/02; G07C 5/08

(52) U.S. Cl. CPC G01N 25/72; B60C 25/007; G01M 17/027; G07C 5/0816

(57) ABSTRACT

A tire failure determination method according to the present disclosure is an information processing method to be executed by an information processing apparatus, the information processing apparatus including a controller, a communication interface, and a storage and being capable of communicating with a network via the communication interface, the information processing method including, via the controller, acquiring a thermal image of a tire captured by an infrared camera, specifying a position of a damaged portion in the tire from the thermal image, specifying a surface temperature of the damaged portion from the thermal image, and estimating a depth of the damaged portion based on the position and the surface temperature.

### CROSS-REFERENCE TO RELATED APPLICATION

The present application claims priority to Japanese Patent Application No. 2023-090197 filed on May 31, 2023, the entire contents of which are incorporated herein by reference.

### TECHNICAL FIELD

The present disclosure relates to an information processing method and an information processing apparatus.

### BACKGROUND

Techniques for determining tire failure are known. For example, PTL 1 discloses a tire damage detection system that detects the size of an external damage portion of a tire based on the diameter of a rim wheel, using image data of a tire assembled to the rim wheel.

### CITATION LIST

### Patent Literature

PTL 1: JP 2019-202729 A

### SUMMARY

### Technical Problem

However, there is a demand for further improvement in the usefulness of techniques for determining tire failure. For example, in mining vehicles used at mine sites, when a sudden tire failure occurs, productivity decreases due to the occurrence of operations such as transportation by the mining vehicle and tire replacement. In addition, periodic tire inspections by workers to prevent sudden failures impose a cost burden. Therefore, automation of tire failure determination is required.

In view of these circumstances, an object of the present disclosure is to improve the usefulness of techniques for determining tire failure.

### Solution to Problem

[1] An information processing method according to one embodiment of the present disclosure is
an information processing method executed by an information processing apparatus,
the information processing apparatus including a controller, a communication interface, and a storage, and being capable of communicating with a network via the communication interface,
wherein the controller:
acquires a thermal image of a tire captured by an infrared camera;
specifies a position of a damaged portion in the tire from the thermal image;
specifies a surface temperature of the damaged portion from the thermal image; and
estimates a depth of the damaged portion based on the position and the surface temperature.

[2] The information processing method according to one embodiment of the present disclosure is,
in the information processing method described in [1] above,
wherein the tire comprises a carcass ply,
the carcass ply comprises a turn-up portion,
and the method preferably includes determining whether the position of the damaged portion is in a region where the turn-up portion is present, and estimating the depth based on the result of the determination and the surface temperature.

[3] The information processing method according to one embodiment of the present disclosure is,
in the information processing method described in [2] above,
preferably including storing, in the storage, a correspondence relationship between the surface temperature and the depth for each of a case in which the position is in a region where the turn-up portion is present and a case in which the position is in a region where the turn-up portion is not present, and estimating the depth based on the correspondence relationship.

[4] The information processing method according to one embodiment of the present disclosure is,
in the information processing method described in any one of [1] to [3] above,
preferably including acquiring an inner cavity temperature of the tire, and estimating the depth of the damaged portion based on the position, the surface temperature, and the inner cavity temperature.

[5] The information processing method according to one embodiment of the present disclosure is,
in the information processing method described in any one of [1] to [4] above,
preferably including determining a relative relationship among surface temperatures acquired for each of a plurality of damaged portions in the tire from the thermal image, and notifying a user of an alert based on a result of determining the relative relationship.

[6] An information processing apparatus according to one embodiment of the present disclosure is
an information processing apparatus including a controller, a communication interface, and a storage, and being capable of communicating with a network via the communication interface,
wherein the controller is configured to execute operations comprising:
acquiring a thermal image of a tire captured by an infrared camera;
specifying a position of a damaged portion in the tire from the thermal image;
specifying a surface temperature of the damaged portion from the thermal image; and
estimating a depth of the damaged portion based on the position and the surface temperature.

### Advantageous Effect

According to the present disclosure, it is possible to improve the usefulness of techniques for determining tire failure.

### BRIEF DESCRIPTION OF THE DRAWINGS

In the accompanying drawings:

FIG. 1 is a diagram illustrating a schematic configuration of an information processing system according to one embodiment of the present disclosure;

FIG. 2 is a block diagram illustrating the configuration of the information processing apparatus depicted in FIG. 1;

FIG. 3 is a diagram illustrating an example of a thermal image;

FIG. 4 is a diagram illustrating a cross-sectional view of a tire and the like; and

FIG. 5 is a flowchart illustrating the operation of the information processing apparatus.

### DETAILED DESCRIPTION

Hereinafter, an information processing system S according to an embodiment of the present disclosure will be described with reference to the drawings. It should be noted that the drawings are schematic, and the ratios of the respective dimensions may differ from those in reality.

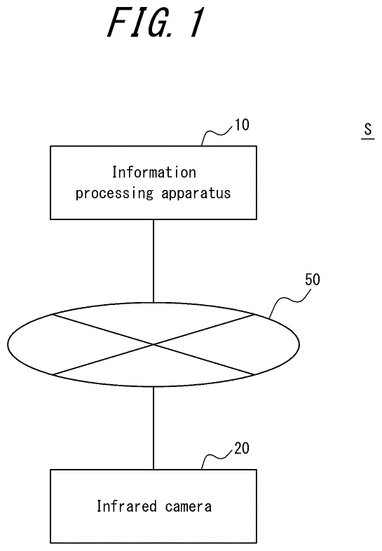

With reference to FIG. 1, an overview of the information processing system S according to the present embodiment will be described. As illustrated in FIG. 1, the information processing system S includes an information processing apparatus 10 and an infrared camera 20, which are capable of communicating with each other. In FIG. 1, one information processing apparatus 10 and one infrared camera 20 are depicted, respectively. However, the information processing system S may include any number of information processing apparatuses 10 and infrared cameras 20.

The information processing apparatus 10 is constituted by one or more computers. In the present embodiment, the information processing apparatus 10 will be described as being constituted by a single computer. However, the information processing apparatus 10 may be constituted by a plurality of computers, such as a cloud computing system. In the present disclosure, the information processing apparatus 10 may also be referred to as a “tire failure determination apparatus.”

The infrared camera 20 is constituted by a computer including one or more cameras. The infrared camera 20 may be, for example, a thermographic camera capable of capturing thermal images. The images captured by the infrared camera 20 may be still images or moving images. The infrared camera 20 generates a thermal image of a tire and transmits it to the information processing apparatus 10. In the present embodiment, the thermal image of the tire includes at least a part of the tire. The thermal image may include, in addition to at least a part of the tire, at least a part of the vehicle on which the tire is mounted.

The infrared camera 20 may be, for example, a fixed camera installed along the travel route of vehicles at a mine site. Thus, the infrared camera 20 can capture images of vehicles traveling along the travel route, making it less likely to reduce the operation rate of vehicles and productivity at the mine. However, the infrared camera 20 is not limited to a fixed camera and may be a movable camera, such as a camera mounted on a drone or a tablet device that can be carried by a person.

The network 50 is any communication network that enables mutual communication between the information processing apparatus 10 and the infrared camera 20. The network 50 may be, for example, the Internet, a mobile communication network, a fixed communication network, a LAN (Local Area Network), or a combination thereof.

In the present disclosure, the tire is not particularly limited, but may be an OR (Off The Road) tire mounted on a mining vehicle such as a transport vehicle, construction vehicle, work vehicle, or heavy machinery vehicle used at a mine site or the like. However, the tire may be a tire other than an OR tire.

Also, in the present disclosure, the vehicle is, for example, a mining vehicle used at a mine site or the like. However, the vehicle is not limited to the above-described mining vehicle and may be any vehicle capable of mounting a tire, such as a transport vehicle, construction vehicle, work vehicle, heavy machinery vehicle, bus, passenger vehicle, motorcycle, bicycle, or airplane.

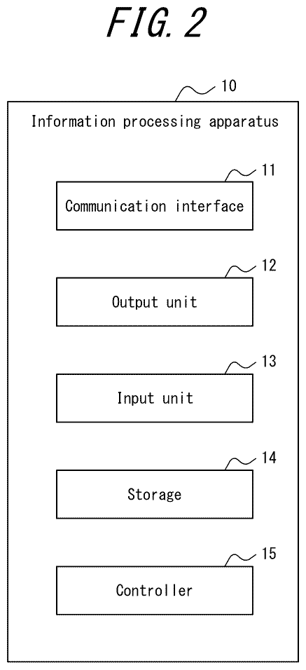

With reference to FIG. 2, the configuration of the information processing apparatus 10 will be described. FIG. 2 is a block diagram depicting the configuration of the information processing apparatus 10. The information processing apparatus 10 includes a communication interface 11, an output unit 12, an input unit 13, a storage 14, and a controller 15. In the information processing apparatus 10, the communication interface 11, output unit 12, input unit 13, storage 14, and controller 15 are connected to be capable of communicating with each other via wired or wireless connections.

The communication interface 11 includes a communication module for connecting to the network 50. The communication module may be, for example, a communication module compatible with mobile communication standards such as 4G (4^{th} Generation) or 5G (5^{th} Generation). The communication module may also be a communication module compatible with standards such as wired LAN or wireless LAN. The communication module may further be a communication module compatible with near field communication standards such as Wi-Fi® (Wi-Fi is a registered trademark in Japan, other countries, or both), Bluetooth® (Bluetooth is a registered trademark in Japan, other countries, or both), or infrared communication. In the present embodiment, the information processing apparatus 10 is connected to the network 50 via the communication interface 11. As a result, the information processing apparatus 10 can communicate with the infrared camera 20 or other computers and the like.

The output unit 12 includes one or more output devices. The output device may be, for example, a display, speaker, or lamp. Thus, the output unit 12 outputs images, sound, light, or the like.

The input unit 13 includes one or more input devices. The input device may be, for example, a touch panel, camera, or microphone. The input unit 13 receives input operations by a user of the information processing apparatus 10, for example.

The storage 14 may be, for example, a semiconductor memory, magnetic memory, or optical memory. The storage 14 functions as, for example, a main storage device, auxiliary storage device, or cache memory. The storage 14 stores any information used for the operation of the information processing apparatus 10. For example, the storage 14 stores a system program, application program, embedded software, or database. The information stored in the storage 14 may be updated by information acquired from the network 50 via the communication interface 11, for example.

For example, the storage 14 may store tire identification information for one or more tires to be subjected to failure determination. In the present disclosure, the tire identification information is also referred to as a tire ID (Identifier). The tire identification information of a tire is information that can uniquely identify the tire. The tire identification information of a tire may be, for example, uniquely generated by the information processing apparatus 10, but is not limited thereto, and may be a manufacturing number of the tire or a vehicle number of the vehicle on which the tire is mounted. Furthermore, the storage 14 may store tire-related information related to the tire in association with the tire identification information.

The tire-related information includes any information related to the tire. The tire-related information may include, for example, distance information from the surface of the tire to the carcass ply, damage information of the tire, configuration information of the tire, information of the vehicle on which the tire is mounted, or position information of the tire mounted on the vehicle. The damage information of the tire may be information including, for example, the position, shape, depth, and registration date and time of damage previously sustained by the tire. The configuration information of the tire may include, for example, the type, model number, material properties, tread pattern, belt angle, size, or weight of the tire. The information of the vehicle on which the tire is mounted includes vehicle identification information, type, model number, displacement, number of mounted tires, or number of shafts.

The controller 15 includes one or more processors. The processor may be, for example, a general-purpose processor such as a CPU (Central Processing Unit), or a dedicated processor specialized for specific processing. The controller 15 is not limited to a processor and may include one or more dedicated circuits. The dedicated circuit may be, for example, an FPGA (Field-Programmable Gate Array) or an ASIC (Application Specific Integrated Circuit). The controller 15 controls each of the above-described components, such as the communication interface 11, output unit 12, input unit 13, and storage 14, to realize the functions of the information processing apparatus 10, including the functions of the respective components.

The controller 15 of the information processing apparatus 10 acquires a thermal image from the infrared camera 20 via the communication interface 11 and the network 50 at any point in time.

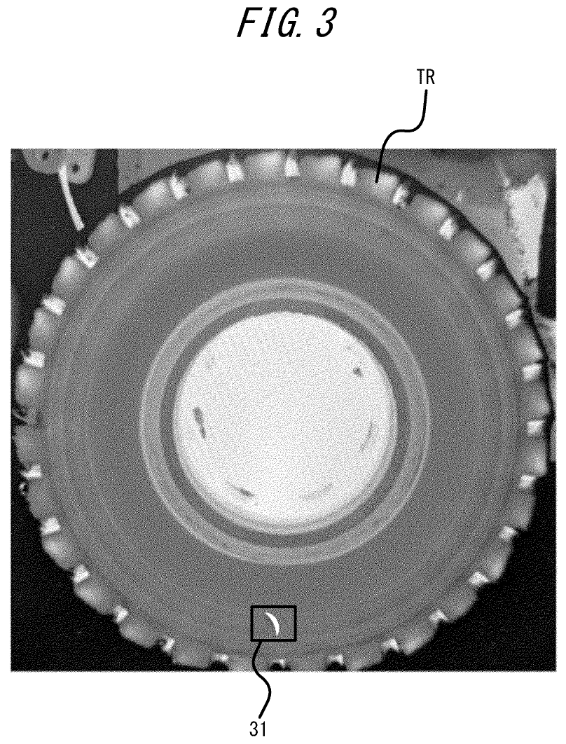

FIG. 3 illustrates an example of a thermal image. The thermal image is a captured image of a tire TR. The controller 15 performs image analysis on the thermal image to specify the position of a damaged portion 31 on the surface of the tire TR and the surface temperature of the damaged portion of the tire TR. The method of specification is arbitrary.

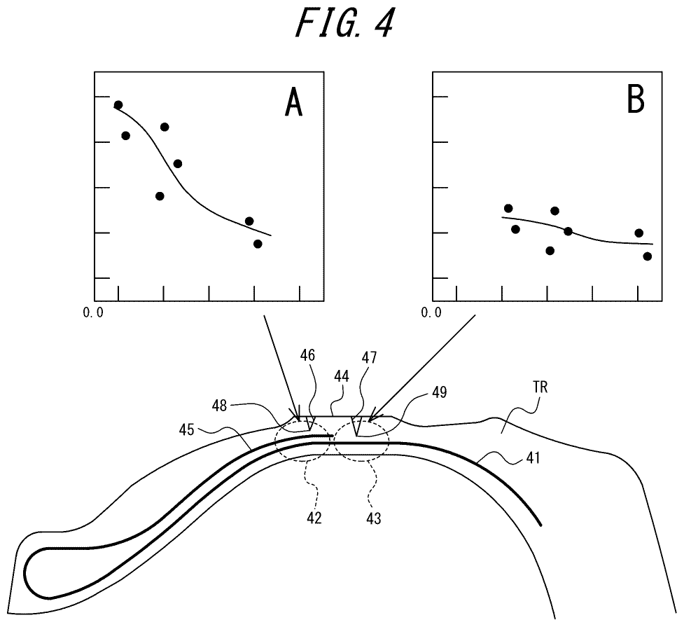

FIG. 4 depicts a cross-sectional view of the tire TR. The tire TR includes a carcass ply 41 inside. The carcass ply 41 includes a turn-up portion 45. Therefore, the tire TR includes a region 42 where the turn-up portion 45 is present and a region 43 where the turn-up portion 45 is not present.

On the inner cavity side of the damaged portion 46 on the surface 44, the turn-up portion 45 of the carcass ply 41 is present. On the inner cavity side of the damaged portion 47, the turn-up portion 45 is not present. In this case, the surface temperature of the damaged portion 46 and the surface temperature of the damaged portion 47 exhibit different changes. The relationship between the surface temperature of the damaged portion 46 and the distance from the carcass ply 41 (here, the turn-up portion 45) in the region 42 to the tip 48 of the damaged portion 46 is indicated in graph A of FIG. 4. The relationship between the surface temperature of the damaged portion 47 and the distance from the carcass ply 41 in the region 43 to the tip 49 of the damaged portion 47 is indicated in graph B of FIG. 4. As depicted in graphs A and B, the increase width (i.e., sensitivity) when the distance from the tip to the carcass ply 41 becomes smaller is greater for the surface temperature of the damaged portion 46 than for the surface temperature of the damaged portion 47. In other words, even at the same distance, the surface temperature of the damaged portion is relatively high in a region where the turn-up portion 45 is present. The reason is considered to be that the damaged portion is affected by the heat of the turn-up portion 45.

The correspondence relationship between the distance from the carcass ply 41 to the tip of the damaged portion and the surface temperature of the damaged portion is stored in the storage 14 for each of the cases where the position of the damaged portion is in a region where the turn-up portion 45 is present (for example, graph A in FIG. 4) and where it is not present (for example, graph B in FIG. 4).

The portion prone to failure in the tire TR is the region where the turn-up portion 45 is present. Therefore, the controller 15 determines whether the position of the specified damaged portion is in a region where the turn-up portion 45 is present, based on the specified position of the damaged portion and the tire-related information stored in the storage 14. The controller 15 specifies, in the storage 14, the correspondence relationship between the distance from the carcass ply 41 to the tip of the damaged portion and the surface temperature of the damaged portion, based on the determination result. The controller 15 applies the surface temperature specified from the thermal image to the correspondence relationship between the distance from the carcass ply 41 to the tip of the damaged portion and the surface temperature of the damaged portion, to specify the distance from the carcass ply 41 to the tip of the damaged portion. The controller 15 estimates the depth of the damaged portion by subtracting the specified distance from the distance from the surface 44 of the tire TR to the carcass ply 41. The units of distance and depth may be, for example, [mm] or [cm]. With this configuration, the controller 15 can improve the estimation accuracy of the depth of the damaged portion and enhance the usefulness of the technique for determining tire failure.

As an alternative example, the controller 15 may estimate the depth of the damaged portion based on whether the damaged portion is in a region where the turn-up portion 45 is present and the surface temperature of the damaged portion. With this configuration, since the controller 15 estimates the depth in consideration of whether the position of the damaged portion is in the turn-up portion, the estimation accuracy can be further improved. The estimation may be performed by any depth estimation algorithm (for example, a calculation formula), or may be performed based on the correspondence relationship between whether the damaged portion is in a region where the turn-up portion 45 is present and the surface temperature of the damaged portion. With this configuration, the controller 15 can adopt different estimation methods depending on whether the position of the damaged portion is in the turn-up portion, thereby further improving estimation accuracy. The depth estimation algorithm may be constructed by a statistical method such as machine learning or deep learning, using the surface temperature of the damaged portion and the depth of the damaged portion measured by a human or the like as training data.

Additionally or alternatively, the controller 15 may acquire the inner cavity temperature of the tire TR. With this configuration, the controller 15 can further improve estimation accuracy. The inner cavity temperature is acquired from a tire pressure monitoring system (TPMS: Tire Pressure Monitoring System) installed in the tire TR via the network 50. The controller 15 may estimate the depth of the damaged portion based on the position of the damaged portion, the surface temperature of the damaged portion, and the inner cavity temperature. Any depth estimation algorithm may be used for the estimation of depth.

Additionally or alternatively, the controller 15 may determine the relative relationship among the surface temperatures acquired for each of a plurality of damaged portions in the tire TR from the thermal image. For example, the controller 15 may determine whether a relatively high outlier exceeding a first threshold is included. The controller 15 may notify the user of an alert based on the result of determining the relative relationship. For example, the controller 15 may notify a user terminal operated by the user of an alert via the network 50. The alert may include, for example, prompting inspection of the damaged portion corresponding to the outlier or specifying and presenting the position of the damaged portion corresponding to the outlier. With this configuration, the controller 15 can motivate the user to conduct a more thorough inspection of the damaged portion with particularly high surface temperature among the plurality of damaged portions, and can also prompt the user to simplify or omit inspection of the damaged portion with low surface temperature among the plurality of damaged portions. Thus, the usefulness of the technique for determining tire failure can be improved.

Additionally or alternatively, the controller 15 may transmit damage information regarding damage to the surface of the tire TR to any other terminal via the communication interface 11 and the network 50. The damage information may include, for example, the position, number, or depth of the damaged portion. The damage information is stored in the storage 14 in association with identification information of the damage. The damage information is output as an image, voice, light, or the like at any other terminal. Thus, the information processing apparatus 10 can notify the user of the information processing system S of the damage information, enabling the user to easily grasp the damage. Accordingly, the information processing apparatus 10 can allow the user to plan inspection, repair, replacement, or the like of the tire TR before the tire TR fails. In particular, when the tire TR is replaced, the tire TR may be replaced with a different tire TR according to the damage information of the tire TR. For example, if the surface temperature of the damaged portion of the tire TR is higher than the durable temperature set for the tire TR, the tire TR may be replaced with another type of tire TR with higher heat resistance. Alternatively, if the number of damaged portions of the tire TR is greater than a predetermined number, the tire TR may be replaced with another type of tire TR that is less likely to develop damaged portions. In this way, the user of the information processing system S can adopt a tire TR suitable for use at a mine site based on the damage information of the tire TR.

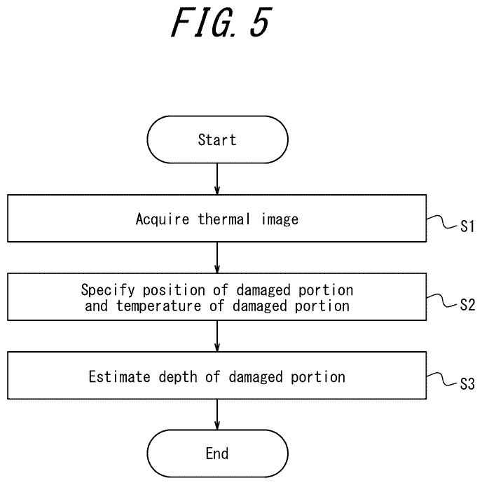

In FIG. 5, a flowchart of the information processing method by the information processing apparatus 10 is depicted.

In step S1, the controller 15 of the information processing apparatus 10 acquires a thermal image of the tire TR captured by the infrared camera 20. The acquisition of the thermal image may be performed periodically or non-periodically. In step S2, the controller 15 specifies the position of the damaged portion and the surface temperature of the damaged portion in the tire TR from the thermal image. In step S3, the controller 15 estimates the depth of the damaged portion based on the specified position and surface temperature.

The present disclosure has been described based on the drawings and embodiments, but it should be noted that those skilled in the art can make various modifications and alterations based on the present disclosure. Therefore, it should be noted that such modifications and alterations are included within the scope of the present disclosure. For example, the configurations or functions included in each embodiment can be rearranged so as not to be logically inconsistent. Also, the configurations or functions included in each embodiment can be used in combination with other embodiments, and it is possible to combine a plurality of configurations or functions into one, divide them, or omit a part thereof.

Also, for example, it is possible to implement an embodiment in which a general-purpose computer functions as the information processing apparatus 10 according to the above-described embodiment. Specifically, a program describing the processing contents for realizing each function of the information processing apparatus 10 according to the above-described embodiment is stored in the memory of a general-purpose computer, and the processor reads and executes the program. Therefore, the present disclosure can also be realized as a program executable by a processor or as a non-transitory computer-readable medium storing the program. Examples of non-transitory computer-readable media include magnetic recording devices, optical disks, magneto-optical recording media, or semiconductor memories.

### INDUSTRIAL APPLICABILITY

According to the present disclosure, the usefulness of a technique for determining tire failure can be improved.

### Contribution to the Sustainable Development Goals (SDGs) Led by the United Nations

SDGs are advocated for the realization of a sustainable society. An embodiment of the present invention can be a technology that contributes to, for example, “No. 9_Build resilient infrastructure, promote inclusive and sustainable industrialization and foster innovation.”

### REFERENCE SIGNS LIST

S: Information processing system

1. An information processing method to be executed by an information processing apparatus,
the information processing apparatus comprising a controller, a communication interface, and a storage and being capable of communicating with a network via the communication interface,
the information processing method comprising, via the controller:
acquiring a thermal image of a tire captured by an infrared camera;
specifying a position of a damaged portion in the tire from the thermal image;
specifying a surface temperature of the damaged portion from the thermal image; and
estimating a depth of the damaged portion based on the position and the surface temperature.

2. The information processing method according to claim 1,
wherein the tire comprises a carcass ply,
wherein the carcass ply comprises a turn-up portion, and
wherein the information processing method comprises determining whether the position of the damaged portion is in a region where the turn-up portion is present, and estimating the depth based on a result of determination and the surface temperature.

3. The information processing method according to claim 2, comprising
storing, in the storage, a correspondence relationship between the surface temperature and the depth for each of a case in which the position is in a region where the turn-up portion is present and a case in which the position is in a region where the turn-up portion is not present, and
estimating the depth based on the correspondence relationship.

4. The information processing method according to claim 1, comprising
acquiring an inner cavity temperature of the tire, and
estimating the depth of the damaged portion based on the position, the surface temperature, and the inner cavity temperature.

5. The information processing method according to claim 1, comprising
determining a relative relationship among surface temperatures acquired for each of a plurality of damaged portions in the tire from the thermal image, and
notifying a user of an alert based on a result of determining the relative relationship.

6. An information processing apparatus comprising a controller, a communication interface, and a storage, the information processing apparatus being capable of communicating with a network via the communication interface,
wherein the controller is configured to execute operations comprising:
acquiring a thermal image of a tire captured by an infrared camera;
specifying a position of a damaged portion in the tire from the thermal image;
specifying a surface temperature of the damaged portion from the thermal image; and
estimating a depth of the damaged portion based on the position and the surface temperature.

7. The information processing method according to claim 2, comprising
acquiring an inner cavity temperature of the tire, and
estimating the depth of the damaged portion based on the position, the surface temperature, and the inner cavity temperature.

8. The information processing method according to claim 2, comprising
determining a relative relationship among surface temperatures acquired for each of a plurality of damaged portions in the tire from the thermal image, and
notifying a user of an alert based on a result of determining the relative relationship.

9. The information processing method according to claim 3, comprising
acquiring an inner cavity temperature of the tire, and
estimating the depth of the damaged portion based on the position, the surface temperature, and the inner cavity temperature.

10. The information processing method according to claim 3, comprising
determining a relative relationship among surface temperatures acquired for each of a plurality of damaged portions in the tire from the thermal image, and
notifying a user of an alert based on a result of determining the relative relationship.

11. The information processing method according to claim 4, comprising
determining a relative relationship among surface temperatures acquired for each of a plurality of damaged portions in the tire from the thermal image, and
notifying a user of an alert based on a result of determining the relative relationship.
